(19) United States
(12) Patent Application Publication
(10) Pub. No.: US 2006/0165848 A1
(43) Pub. Date: Jul. 27, 2006

(54) Sour dough the use thereof and bakery products products produced from the same

(75) Inventors: Emilie Bryckaert, Roubaix (FR); Pascal Lejeune, Tourcoing (FR); Evelyne Fonchy-Penot, Fleurbaix (FR); Didier Colavizza, Auralille (FR)

Correspondence Address: FOLEY AND LARDNER LLP;SUITE 500, 3000 K STREET NW, WASHINGTON, DC, 20007, US

(73) Assignee: Lesaffre Et Compagnie

(21) Appl. No.: 10/548,572

(22) PCT Filed: Mar. 12, 2004
(86) PCT No.: PCT/EP04/02626

§ 371 Date: Mar. 21, 2006

(30) Foreign Application Priority Data
Mar. 12, 2003 (EP) 03005610.5
Jul. 31, 2003 (EP) 03017340.5

(51) Int. Cl. A21D 13/00

(52) U.S. Cl. 426/94

(57) ABSTRACT

Method for the manufacture of ready-to-use sourdough baker's leavens containing homofermentative lactic acid bacteria, said method making it possible to vary the fermentation quotient of said sourdough baker's leavens sourdough baker's leavens capable of being obtained by this method and use of said sourdough baker's leavens in breadmaking.

The present invention relates to a ready-to-use sourdough baker's leaven, a method for its preparation and its use in breadmaking.

The specificities of sourdough breadmaking are well known:
obtaining a popular sourdough bread flavor, in particular characterized by a sourish or acetic smell of the crumb;
obtaining a bread having a characteristic texture of leavened bread;
obtaining a bread which can keep for longer than unleavened bread of the same type.

These flavor, texture and storage characteristics are due to the fermentation carried out by the living microorganisms of the leaven, and in particular by its bacteria. They are why leavened bread is sought after by the consumer.

It should be noted that the set of qualities of sourdough baker's leaven bread: flavor, structure and storage, can only be obtained by incorporation into the bread dough of a ready-to-use sourdough baker's leaven containing a sufficient quantity of living microorganisms.

The incorporation, into the dough, of a deactivated prefermented flour, in dehydrated or liquid form, often called dehydrated or dry or alternatively liquid sourdough does not make it possible to obtain the set of qualities of traditional sourdough bread. These additives, which are known in the bakery sector, only serve to supply flavor molecules, such as acetic acid and lactic acid. They do not make it possible to obtain the characteristic texture and the full flavor of a leavened bread fermented by means of a traditional sourdough baker's leaven.

Breadmaking methods using a traditional sourdough baker's leaven have four disadvantages:
the difficulty for the baker to produce, during each breadmaking process, a sourdough baker's leaven having in substance identical characteristics (live cultures of microorganisms, chemical composition);
the short life of traditional final sourdough baker's leaven (“levain tout point”), even at low temperature,
the daily constraint of refreshing-operation, and
the total duration of breadmaking process, determined by the time between the end of kneading and putting in the oven, which is typically longer than 6 to 7 hours for this type of product.

The ready-to-use sourdough baker's leaven, or final sourdough baker's leaven (“levain tout point”) according to the traditional terminology, is a sourdough baker's leaven which is ready for incorporation into the bread dough or other bakery doughs as fermentation agent.

In the absence of any refreshing operation, excessive acidification appears in the traditional ready-to-use sourdough baker's leaven, causing rapid depletion of the living microorganisms, that is to say microorganisms capable of multiplying and/or fermenting.

To preserve the characteristics of a traditional sourdough baker's leaven, it is thus necessary to carry out several daily refreshing operations.

A refreshing operation corresponds to a fresh supply of flour and water to the sourdough baker's leaven, leading, on the one hand, to a supply of fermentable substances to the microorganisms of the sourdough baker's leaven and, on the other hand, to a dilution of the fermenting medium (leaven). These daily refreshing operations make the work of bakers tedious.

Devices often called “liquid sourdough fermenters” have been proposed in order to reduce the number of refreshments required and to arrive at a situation where the daily requirements to collect sourdough for breadmaking are more or less equivalent to the supply of water and flour necessary to keep the sourdough baker's leaven up. These devices make it possible to control the temperature of the sourdough baker's leaven, thus allowing its storage at low temperature. These devices are often difficult and delicate to manage, especially when the sourdough baker's leaven contains a mixed population of yeasts and bacteria.

To overcome the disadvantage of the lack of reproducibility, professionals have resorted to the preparation of ready-to-use sourdough baker's leaven, often in a single step, with the aid of concentrates of microorganisms for breadmaking. Such concentrates of microorganisms, known under the name “starters” are described in EP-A-0306692. They make it possible to obtain a ready-to-use sourdough baker's leaven within 18 to 24 hours. However, these ready-to-use sourdoughs baker's leaven always have a short life.

An important recent development is the development of a ready-to-use sourdough baker's leaven which can be stored at low temperature for several weeks without any refreshing operation and which allows the baker to use, during each breadmaking process, a sourdough baker's leaven having identical characteristics in substance. Such sourdough baker's leavens are described in EP-A-0953288.

The ready-to-use sourdough baker's leaven described in EP-A-0953288 contains at least unmalted cereal flour and water, was seeded with at least one preparation of heterofermentative lactic acid -bacteria, has a pH between 4 and 4.3 and provides at least 1 thousand million lactic acid bacteria living cells (CFU) per gram for at least 4 weeks if it is stored at less than 10° C. This ready-to-use sourdough baker's leaven allows the fermentation of a baker's dough according to a straight-dough process for the production of a leavened bread.

An important factor for the production of the typical popular flavor of sourdough bread is the ratio between, on the one hand, the lactic acid content and, on the other hand, the acetic acid content of the bread dough. The consumer likes in particular the flavor obtained by the presence of various quantities of acetic acid in the bread dough before baking.

In the present context, the term “lactic acid” denotes the lactic acid CH₃CHOHCOOH as such, the lactic acid salts and the dissociated form CH₃CHOHCOO⁻ (anion) of lactic acid. Likewise, the term “acetic acid” denotes, in the present context, the acetic acid CH₃COOH as such, the acetic acid salts and the dissociated form CH₃COO⁻ (anion) of acetic acid.

In the case of a sourdough bread or similar baked product, the ratio between the lactic acid content and the acetic acid content in the dough for baking is for a significant part determined by the content of these acids in the ready-to-use sourdough which is added to the dough.

Characteristics of the ready-to-use sourdough baker's leaven which play a significant role in the flavor of the sourdough bread are therefore the respective lactic acid content and the acetic acid content of the ready-to-use sourdough baker's leaven, and the ratio between these two contents.

This ratio between, on the one hand, the lactic acid content and, on the other hand, the acetic acid content of a sourdough is expressed by the fermentation ratio or FR which is defined as the ratio of the molar concentration of lactic acid of the sourdough to the molar concentration of acetic acid of the sourdough.

It should be noted that the flavor obtained by the separate introduction of these acids into the leaven or into the bread dough does not make it possible to obtain the true flavor of a sourdough bread because of the absence of the other flavor compounds produced by microorganisms such as lactic acid bacteria. The separate addition of acids moreover causes serious problems of texture on the dough and on the baked product.

In fact, the consumer wishes in particular to buy so-called “natural” sourdough bread, which implies that the bread dough consists solely of natural ingredients such as cereal flour, water, malted cereal flour, biomass, and the like, with the exclusion of so-called “chemical” additives such as purified or pure acetic acid and lactic acid.

Regulations also exist in some countries which ban the use of the name “sourdough baker's leaven bread” or “natural sourdough bread” for any baked product obtained from a dough containing such chemical additives.

It would be advantageous for the baker to be able to have sourdoughs exhibiting various desired specific FRs, and in particular to be able to have such sourdoughs in which the two acids were produced by the microorganisms present in the sourdough.

The present invention allows the manufacturer of sourdough baker's leavens regularly to prepare, with an appropriate selection of microorganisms, ready-to-use sourdough baker's leavens having different FRs.

The present invention more particularly allows the manufacturer of sourdoughs to control, during the preparation of a sourdough, the FR of said sourdough by virtue of the incorporation, into the sourdough, of homofermentative lactic acid bacteria which are not only capable of producing lactic acid by consuming fermentable sugars, but which are also capable of producing acetic acid by consuming lactic acid when there is a deficiency of fermentable sugars, optionally in the presence of an electron acceptor, that is to say in the presence of a substance capable of accepting or gaining at least one electron released during this production of acetic acid by said homofermentative lactic acid bacteria.

In the text which follows, these lactic acid bacteria are referred to by the expression “lactic acid bacteria which bioconvert lactic acid”.

The present invention in particular allows the manufacturer of sourdough baker's leavens to regularly prepare ready-to-use sourdough baker's leavens which have different FRs and which can be stored for several weeks at low temperature.

The present invention also allows the manufacturer of sourdough baker's leavens to regularly prepare ready-to-use sourdough baker's leavens which have different FRs and which may be incorporated into the baker's dough as fermentation agent directly with kneading in the context of a straight-dough process with sourdough baker's leaven, that is to say a process with a single kneading. In such a straight-dough process with sourdough baker's leaven, there are no prefermentation stages other than the fermentations during the preparation of the ready-to-use sourdough baker's leaven according to the invention.

The present invention makes it possible in particular to regularly prepare such sourdough baker's leavens which may be incorporated into the baker's dough, as agent for fermenting and proofing this dough, directly with kneading in the context of a straight-dough process with sourdough baker's leaven with a period between the start of kneading and baking of less than or equal to 6 hours, or even preferably less than or equal to 4 hours.

The present invention first of all relates to a ready-to-use sourdough baker's leaven.

In the present context, the term “breadmaking” and “bread” and the terms “bakery” and “baker” should be interpreted broadly as referring to the fields of baking and yeast raised sweet pastries (“viennoiseries”), and in general to the field of production of products baked in the oven from flour-based fermented doughs. Thus, the sourdough baker's leaven according to the invention may be a ready-to-use sourdough baker's leaven intended for the manufacture of a bakery product of the bread, brioche or yeast raised sweet pastry type (“viennoiserie”).

In the text which follows, unless otherwise stated, the term “sourdough” systematically means “ready-to-use sourdough baker's leaven”.

The ready-to-use sourdough according to the invention consists of a culture medium based on flour containing at least one cereal flour and water, said culture medium being seeded and fermented with a selection of microorganisms which comprises lactic acid bacteria, at least some of the lactic acid bacteria of the selection being homofermentative lactic acid bacteria which bioconvert lactic acid.

In the present context “flour-based culture medium” denotes a culture medium in which the main ingredient of the dry matter content is one or more cereal flours.

The term “cereal flour” as used in the present context relates to products rich in starch obtained from the milling of cereal grain. This term covers the flours from one or more unmalted cereals, the flours from one or more malted cereals, and the flours from a combination of one or more unmalted cereals and one or more malted cereals. The term “cereal flour”, on the other hand, does not cover denatured derivatives of cereal flour, such as the products called “gelatinized flour” or “pregelatinized flour” or products termed “flours” in which the starch has been subjected, to complete or practically complete hydrolysis.

The sourdough according to the invention contains at least 7 g/l of acetic acid. The sourdough according to the invention optionally also contains lactic acid.

The FR of the sourdough according to the invention is less than or equal to 4.75.

The sourdough according to the invention contains at least 100 million (10⁸) CFUs (colony forming units) of lactic acid bacteria per gram, of which at least 60% is CFU of homofermentative lactic acid bacteria which bioconvert lactic acid.

The sourdough according to the invention has a pH of between 3.8 and 4.5.

According to the invention, the content, in the sourdough, of sugars fermentable by the microorganisms of sourdough is less than 5 g/kg.

The sourdough according to the invention advantageously comprises at least 1 thousand million −10⁹) CFUs of lactic acid bacteria per gram.

Lactic acid bacteria are divided into three separate classes or groups:
class or group I covers the so-called strict homofermentative lactic acid bacteria;
class or group II covers the so-called facultative heterofermentative or facultative homofermentative-heterofermentative lactic acid bacteria; and
class or group III covers the so-called strict heterofermentative lactic acid bacteria.

This classification of lactic acid bacteria is described in particular in the reference manual “Bacteries lactiques” by H. de Roissart and E. M. Luquet, published in 1994 by Lorica, ISBN: 2-9507477-0-1.

The term “homofermentative lactic acid bacteria” as used in the present context covers classes or groups I and II lactic acid bacteria, that is to say the strict homofermentative lactic acid bacteria and the facultative homofermentative-heterofermentative lactic acid bacteria. The term “homofermentative” as used in the present context therefore covers both the term “strict homofermentative” and the term “facultative homofermentative-heterofermentative”.

The homofermentative lactic acid bacteria which bioconvert lactic acid of the sourdough according to the invention are therefore chosen from the group comprising the strict homofermentative lactic acid bacteria, the facultative homofermentative-heterofermentative lactic acid bacteria and mixtures of said bacteria, it being possible for said mixtures to be mixtures of strict homofermentative lactic acid bacteria, mixtures of facultative homofermentative-heterofermentative lactic acid bacteria and mixtures consisting of one or more strict homofermentative lactic acid bacteria and one or more facultative homofermentative-heterofermentative lactic acid bacteria.

In the present context, the term “mixture of bacteria” refers to a combination of bacteria belonging to different strains.

Advantageously, in the sourdough according to the invention, at least 75%, and preferably at least 95% of the CFUs of lactic acid bacteria are CFUs of homofermentative lactic acid bacteria which bioconvert lactic acid. The invention relates in particular to such sourdoughs in which all or in substance all (that is to say at least 99%) of the CFUs of lactic acid bacteria are CFUs of homofermentative lactic acid bacteria which bioconvert lactic acid.

Advantageously, the sourdough according to the invention has an FR of less than or equal to 4.00, preferably of less than or equal to 3.00.

According to one embodiment, the sourdough according to the invention contains at least 10 g/l of acetic acid. The sourdough according to the invention typically comprises acetic acid and lactic acid. Thus, according to a useful embodiment, the sourdough according to the invention has an FR of 0.40 to 4.75, preferably of 1.50 to 4.00 and preferably still of 2.00 to 3.00.

The pH of the sourdough according to the invention is preferably 4.0 to 4.3.

The sourdough according to the invention advantageously has a content of sugars fermentable by the micro-organisms of the sourdough of less than 3 g/kg, and preferably still of less than 1 g/kg.

In general, for the preservation of the sourdough which is in substance unchanged at low temperature, that is to say at a temperature equal to or less than 8° C., preferably less than 4° C., it is desirable to have in the sourdough a fermentable sugar content which is as low as possible during this storage.

As indicated above, the sourdough according to the invention contains at least 10⁸ and preferably at least 10⁹ CFU of lactic acid bacteria per gram, of which at least 60%, preferably at least 75%, and preferably still at least 95% is CFUs of homofermentative lactic acid bacteria which bioconvert lactic acid.

Advantageously, said CFUs of homofermentative lactic acid bacteria which bioconvert lactic acid include CFUs of homofermentative Lactobacilli. Preferably, at least 60%, preferably still at least 75%, more preferably still at least 85%, and even all or in substance all (at least 99%) of said CFUs of homofermentative lactic acid bacteria which bioconvert lactic acid of the sourdough according to the invention is CFUs of homofermentative Lactobacilli. As indicated above in general in relation to the homofermentative lactic acid bacteria, homofermentative Lactobacilli which bioconvert the lactic acid of the sourdough according to the invention are chosen from the group comprising the strict homofermentative Lactobacilli, the facultative homofermentative-heterofermentative Lactobacilli, and mixtures of said Lactobacilli.

The sourdough according to the invention may contain for example homofermentative lactic acid bacteria which bioconvert lactic acid chosen from the group comprising the Lactobacilli, the Carnobacilli, the Lactococci, the Streptococci, the Pediococci and combinations of said bacteria. Of course, the homofermentative lactic acid bacteria which bioconvert lactic acid should be nonpathogenic.

The sourdough according to the invention may contain for example homofermentative lactic acid bacteria which bioconvert lactic acid belonging to a strain chosen from the group comprising the species Pediococcus acidilactici, Streptococcus lactis and thermophilus, Lactobacillus bulgaricus, lactis, helveticus, salivarius, curvatus, sake and pentosus, delbrueckii, farciminis, acidophilus, plantarum, casei and rhamnosus and combinations of said species. The species particularly preferred are Streptococcus thermophilus and Lactobacillus delbrueckii, farciminis, acidophilus, plantarum, casei and rhamnosus. An example of such a strain is the Lp 652 strain of Lactobacillus plantarum, deposited by Lesaffre International—147 Rue Gabriel Péri—59700 MARCQ EN BAROEUL—France, on Jul. 16, 2003 according to the Budapest Treaty at the CNCM (Collection Nationale de Cultures de Microorganismes), Institut Pasteur, 25, Rue du Docteur Roux, F-75724 Paris (France) under the registration number CNCM I-3069.

The sourdough according to the invention may also comprise yeasts. In this case, the sourdough typically comprises at least one hundred thousand (10⁵), preferably at least 1 million (10⁶) and preferably still at least 5 million (5×10⁶) CFUs of yeasts. The yeasts present in a sourdough according to the invention are typically yeasts belonging to yeast species commonly present in the biomass of sourdoughs. The sourdough according to the invention may notably comprise CFUs of yeasts chosen from the group of the species Saccharomyces and Candida and combinations of said yeasts, and in particular Saccharomyces cerevisiae and its various varieties.

The sourdough according to the invention may contain for example yeasts belonging to a strain chosen from the group comprising Saccharomyces cerevisiaei Saccharomyces exiguus, Saccharomyces dairensis, Saccharomyces turbidans, Torula delbrueckii, Torula or Candida holmii, Candida colliculosa, Candida tropicalis, Candida krusei; Candida milleri, Candida boidinii, Candida robusta, Pichia saitoi and combinations of said yeasts.

The sourdough according to the invention may also contain an enzymatic preparation. This enzymatic preparation typically comprises one or more of the following enzymes: α-amylase, β-amylase, amyloglucosidase, pentosanase and xylanase and in particular one or more fungal amylases.

Unmalted cereal flours, and in particular malted cereal flours are sources of amylase. However, if there is a lack of amylase in the sourdough, the latter may be supplemented by adding malted cereal flour (such as a malted wheat flour) and/or by the incorporation, into the sourdough, of an enzymatic preparation containing amylase, such as for example fungal amylase. This enzymatic preparation may also have enzymatic activities other than an amylase activity.

In the present context, the term “enzymatic preparation” relates to enzyme supplements incorporated into the sourdough, and does not cover the malted and/or unmalted cereal flour as such.

A sourdough according to the invention may advantageously comprise an unmalted rye four as unmalted cereal flour. A sourdough according to the invention may thus comprise unmalted rye flour and malted cereal flour, such as in particular malted wheat flour.

The sourdough according to the invention may, depending on its dry matter content, be provided in liquid form or in pasty form. The sourdough according to the invention may in particular usefully have a dry matter content between 12 and 50% by mass, preferably between 13 and 35% by mass, and preferably still between 15 and 20% by mass. According to one embodiment, the sourdough according to the invention has a dry matter content between 15 and 35% by mass or between 13 and 20% by mass.

When the sourdough according to the invention is liquid, it advantageously contains a food additive chosen from the group comprising food thickeners and food stabilizers.

The sourdough according to the invention makes it possible to combine the following advantages:
the sourdough is ready-to-use, that is to say that it is ready to be incorporated into a baker's dough as fermentation agent;
the sourdough allows the baker to use, during each breadmaking operation, a sourdough having characteristics which are identical in substance,
the sourdough may be industrially manufactured with a particular desired FR being regularly obtained.

The invention makes it possible notably to produce ready-to-use sourdoughs with low FRs predominantly containing homofermentative lactic acid bacteria, which are generally more active than the heterofermentative bacteria, whereas traditionally sourdoughs with low FRs are obtained with predominantly strict heterofermentative bacteria. The use of these generally highly acidifying homofermentative bacteria also allows the baker to shorten the fermentation time of his final dough.

The invention also makes it possible to produce ready-to-use sourdoughs which preserve their properties and in particular a flora having the CFU values defined above, for at least one month if they are stored at a temperature equal to or less than 8° C.

Among leavened breads, those whose fermentation agent is essentially a sourdough and whose crumb has a pH ≦4.3, preferably ≦4.2, an acetic acid content of at least 900 ppm by weight and preferably a lactic acid content of at least 4000 ppm by weight are particularly sought after. Such leavened breads are described in particular in the French decree No. 93-1074, called “Decret Pain”.

The fermentation agent is essentially a sourdough when the dose of baker's yeast added in addition to the sourdough is equal to or less than 0.2% by weight (expressed as equivalent quantity of fresh or compressed yeast at 32% by weight of dry matter content) relative to the flour used, excluding the flour provided by the sourdough. This obviously also includes the case where no baker's yeast is added in addition to the sourdough. In the case where a dose of baker's yeast is added in addition to the sourdough, said baker's yeast may be added in various forms having dry matter contents, and therefore yeast cells, which are variable, such as for example dry yeast, compressed or crumbled yeast and liquid yeast. A compressed yeast typically has a dry matter content of 27 to 35% by weight.

In the text which follows, unless otherwise stated, the dose of baker's yeast added is systematically expressed in terms of equivalent quantity of fresh or compressed yeast at 32% by weight of dry matter content.

An important advantage of the present invention is that it covers sourdoughs which make it possible to obtain a leavened bread whose crumb is characterized in that it has a pH ≦4.3, preferably ≦4.2, an acetic acid content of at least 900 ppm by weight and preferably a lactic acid content of at least 4000 ppm by weight, in a short breadmaking process and in particular in a breadmaking process having a fermentation time between the start of kneading and the start of baking of less than 4 hours 30 minutes, for example of about 4 hours, in particular with a fermentation agent which is essentially this sourdough.

In general, if the fermentation agent is essentially the sourdough according to the invention, the production of a leavened bread will require at least 3 hours 30 minutes of fermentation between the start of kneading and the start of baking, preferably at least 3 hours 45 minutes.

In general, the production of a bread according to the invention will require at least 2 hours 30 minutes of fermentation, preferably at least 3 hours.

The present invention also relates to strains of homofermentative lactic acid bacteria which bioconvert lactic acid and which are appropriate for the sourdough according to the invention. These strains may be commercial strains or preferably for example the Lp 652 strain of Lactobacillus plantarum deposited on Jul. 16, 2003 at the CNCM under the registration number CNCM I-3069, a strain which has proved advantageous for the sourdough according to the invention and its manufacture.

The present invention also relates to methods allowing the manufacture of a sourdough according to the invention.

The invention thus relates to methods for the manufacture of sourdoughs according to the invention in which homofermentative lactic acid bacteria specifically selected for their capacity to produce acetic acid by consuming lactic acid when there is a deficiency of fermentable sugars and optionally in the presence of an electron acceptor are used. Said homofermentative lactic acid bacteria which bioconvert lactic acid are used, on the one hand, for the formation of lactic acid by fermentation of fermentable sugars and, on the other hand, for the production of acetic acid from lactic acid when there is substantial deficiency of fermentable-sugars.

According to one embodiment, the invention relates to a method for the manufacture of a ready-to-use sourdough according to the invention, said method comprising:
the selection of microorganisms;
the preparation of a flour-based culture medium;
the seeding of the culture medium;
a first fermentation of the culture medium, and
a second fermentation of the culture medium.

According to this method of manufacture, a selection of microorganisms is made, this selection containing lactic acid bacteria, and in particular homofermentative lactic acid bacteria which bioconvert lactic acid. Said selection may consist solely of one or more homofermentative lactic acid bacteria and in particular of one or more homofermentative lactic acid bacteria which bioconvert lactic acid. Said selection may also comprise other microorganisms such as, for example, one or more yeasts and/or one or more strains of heterofermentative lactic acid bacteria.

According to this method, a flour-based culture medium is prepared, this medium containing at least one cereal flour and water. Said flour-based culture medium may, where appropriate, also comprise other ingredients, and in particular ingredients capable of promoting microbial growth, such as in particular yeast autolyzate.

The flour-based culture medium thus prepared is seeded with the selection of microorganisms.

According to this method, a first fermentation of the flour-based culture medium is carried out by means of this selection of microorganisms. During this first fermentation of the culture medium, the homo-fermentative lactic acid bacteria of the selection produce lactic acid by consuming fermentable sugars present in the culture medium. This first fermentation of the culture medium is allowed to continue until there is substantial depletion of the fermentable sugars by the microorganisms of the selection.

In practice, persons skilled in the art consider that there is substantial deficiency, substantial absence or substantial depletion of fermentable sugars when the fermentable sugar content in the medium is and remains less than 2 g/kg, preferably less than 1 g/kg.

After the first fermentation of the culture medium, a second fermentation of this culture medium is carried out by the microorganisms of the selection in the presence of substantial deficiency of fermentable sugars. During this second fermentation, and due to the specific selection of the microorganisms, there is consumption of lactic acid and production of acetic acid (designated hereinafter by the term “consumption/production of acids”) by the homofermentative lactic acid bacteria which bioconvert lactic acid. The second fermentation is optionally carried out in the presence of an electron acceptor. This second fermentation of the culture medium is continued until the desired FR is obtained in the fermented flour-based culture medium.

The method of manufacture described above is performed until a ready-to-use sourdough (fermented flour-based culture medium) according to the invention is obtained, of which the different embodiments have been described above.

It should be noted that if at the end of the first fermentation the culture medium contains an appropriate electron acceptor or if the second fermentation is carried out in the absence of an electron acceptor in the medium, no intervention is necessary for the passage from the first to the second fermentation. In practice, it is sufficient in this case to continue the fermentation of the flour-based culture medium by the microorganisms of the selection beyond the substantial depletion, by these microorganisms, of the fermentable sugars of the culture medium so that this fermentation continues in the presence of a substantial deficiency of fermentable sugars. In the other cases, it is obviously necessary to add an electron acceptor to the culture medium before the second fermentation.

In the method of manufacture according to the invention, the electron acceptor may be chosen in particular according to the nature of the lactic acid bacteria which bioconvert lactic acid of the selection. Usefully, the electron acceptor is chosen from the group comprising: oxygen, citrate, fructose, glycerol and combinations of said components. When the electron acceptor is, or comprises, oxygen, the second fermentation is carried out under aerobic (partial or total) conditions.

As mentioned above, the FR is an important factor for obtaining the popular typical flavor of sourdough bread, and the manufacturer of sourdoughs will therefore continue the second fermentation above until an FR is obtained which gives a sourdough bread having a flavor sought after by the consumer.

The sourdough manufacturer can thus vary the FR of the sourdough produced by varying the duration of the second fermentation of the culture medium.

According to one variant of the methods of manufacture according to the invention, the consumption/production of acids is performed in preculture. The preculture thus obtained is then used, optionally in combination with microorganisms of the selection which have not been used in the preculture, for the fermentation of a culture medium termed “flour-based culture medium”.

According to this variant, a selection of micro-organisms is made which contains lactic acid bacteria including homofermentative lactic acid bacteria, as already described above.

A first culture medium for lactic acid bacteria is prepared containing water and the components necessary for the growth of lactic acid bacteria, such as fermentable sugars.

This first culture medium is seeded with homofermentative lactic acid bacteria which bioconvert lactic acid of the selection.

A first fermentation of the first culture medium is carried out with these homofermentative lactic acid bacteria which bioconvert lactic acid until there is substantial depletion of the fermentable sugars. During this first fermentation of the first culture medium, these homofermentative lactic acid bacteria consume fermentable sugars present in the first medium and produce lactic acid.

After this first fermentation, a second fermentation of the first culture medium is performed with these abovementioned lactic acid bacteria in the presence of a substantial deficiency of fermentable sugars, during which second fermentation these homofermentative lactic acid bacteria produce acetic acid by consuming lactic acid. The second fermentation of the first culture medium is optionally carried out in the presence of an electron acceptor, as already described above. The second fermentation of the first culture medium is continued until a desired intermediate FR in the first culture medium is obtained. In this manner, a preculture of homofermentative lactic acid bacteria which bioconvert lactic acid (first fermented culture medium) is obtained.

According to this variant of the method of manufacture according to the invention, a second culture medium called. “flour-based culture medium” is prepared, said second culture medium containing at least one cereal flour and water.

This flour-based culture medium is seeded with the microorganisms of the selection, on the one hand, by incorporating the first culture in two stages defined above, called “preculture” into this culture medium, and on the other hand, by seeding this culture medium with the microorganisms of the selection which, where appropriate, have not served for the preparation of the preculture.

A fermented flour-based culture medium is obtained by fermentation of this flour-based culture medium by means of the selection of microorganisms.

This variant of the method of manufacture according to the invention is obviously also carried out such that a ready-to-use sourdough (fermented flour-based culture medium) according to the invention is obtained as described above.

In the method of manufacture according to this variant, it is possible to stop the fermentation of the flour-based culture medium as soon as there is substantial depletion of the fermentable sugars present in this medium. It is also possible, in the method according to the variant, to continue the fermentation of the flour-based culture medium beyond the substantial depletion of the fermentable sugars in this medium, and to thus carry out a new fermentation in several stages:
a first fermentation until there is substantial depletion of the fermentable sugars by the microorganisms of the selection, and
a second fermentation in the presence of a substantial deficiency of sugars fermentable by the microorganisms of the selection.

It should be noted that in the method according to the variant, the first culture medium does not necessarily contain, but may contain, cereal flour(s).

The method of manufacture according to the invention, according to the first embodiment or according to its variant embodiment, therefore allows the manufacturer of sourdoughs to reproducibly manufacture ready-to-use sourdoughs for which the manufacturer can chose the FR without addition of exogenous acetic or lactic acids.

Preferably, all the lactic acid or all the acetic acid present in the sourdough were produced by the microorganisms of the selection, which makes it possible to obtain so-called “natural” sourdoughs and leavened breads.

In the first embodiment and the variant of the methods of manufacture according to the invention, the seeding of the culture medium called “flour-based culture medium” may be carried out in a single instance or may be spread out over time. The seeding of the flour-based culture medium in a manner spread out over time may in particular prove (to be) advantageous in the case where the selection of microorganisms comprises microorganisms belonging to different species or strains. It is thus possible to seed the flour-based culture medium with different microorganisms at seeding times spread out over time.

The methods of manufacture according to the invention may also comprise one or more multiplication stages, in which one or more microorganisms of the selection are multiplied before their use for seeding a culture medium.

For a prolonged storage of the sourdough obtained, said sourdough is cooled and stored at a temperature equal to or less than 8° C., preferably equal to or less than 4° C.

It is evident that all the remarks given above in relation to the sourdough according to the invention, and in particular as regards the properties and the composition of the various embodiments of said sourdough, the nature of the selection of micro-organisms, and in particular of the homofermentative lactic acid bacteria and the yeasts which may be present, the nature of the cereal flour and the presence of other ingredients such as an enzymatic preparation containing amylase, also apply to the first embodiment and to the variant methods of manufacture according to the invention.

As regards the presence of an enzymatic preparation containing amylase in the flour-based culture medium, the following should be noted.

The cereal flour contains starch damaged during milling which can be broken down to fermentable sugars by the enzymes of the flour or by amylase. The undamaged or intact starch granules are in principle not degradable by said enzymes.

In the methods of preparation according to the invention, it is particularly desirable that the fermentable sugar content in the fermented flour-based culture medium is as low as possible, and that the fermentable sugar content of the ready-to-use sourdough thus obtained is and remains less than 5 g/kg, preferably less than 3 g/kg, and preferably still less than 1 g/kg during preservation of the sourdough.

It is therefore desired that the damaged starch is as much as possible degraded to fermentable sugars during the methods of manufacture.

Care is taken that the flour-based medium seeded with the microorganisms contains enough amylase, if necessary, by adding an enzymatic preparation containing amylase.

It is also possible to use, in the preparation of the sourdough according to the invention, microorganisms, such as certain lactic acid bacteria, which produce enzymes and in particular amylases.

The invention also relates to the sourdoughs which can be obtained by, or which are obtained by the methods of manufacture according to the invention.

The invention also relates to the use of a sourdough according to the invention as a fermentation agent in the preparation of a leavened dough for bakery products, and in the preparation of a baked bakery product. Said baked bakery product may be any baked leavened bakery product, such as for example of the bread, brioche or yeast raised sweet pastry type (“viennoiseries)”.

The invention therefore relates to a method for the preparation of dough for bakery products comprising the addition of a sourdough according to the invention to the other ingredients of the dough, and to a method for the preparation of a baked bakery product comprising the preparation of a dough by adding a sourdough according to the invention to the other ingredients of the dough and baking the dough thus obtained in an oven.

The ready-to-use sourdough may in particular be used in a straight-dough process as defined above. Said sourdough may thus be used in a straight-dough process comprising a single kneading stage and a baking stage, and a period between the start of kneading and the baking corresponding to the fermentation of less than or equal to 6 hours, and preferably still of less than or equal to 4 hours.

Advantageously, the sourdough according to the invention is added to the other ingredients of the dough as a fermentation agent. Said sourdough may be the only or the main fermentation agent present in the dough. The sourdough according to the invention may also be present in the dough in combination with another fermentation agent such as in particular baker's yeast. In this case, the quantity of baker's yeast added (expressed as equivalent quantity of fresh or compressed yeast at 30% of dry matter) is preferably equal to or less than 1%, preferably still equal to or less than 0.6%, and more preferably still equal to or less than 0.2% by mass relative to the flour used (excluding the flour present in the sourdough according to the invention).

When reference is made to the “Decret pain” (see example 3 below), this dose is equal to or less than 0.2% (expressed as equivalent quantity of fresh or compressed yeast at 32% of dry matter).

The invention thus relates to a method for breadmaking comprising:
the preparation of a bread dough comprising a sourdough according to the invention,
the fermentation of the bread dough, and
the baking of the fermented bread dough, and in particular such a method of breadmaking in which the duration of the fermentation of the bread dough is less than or equal to 6 hours, preferably less than or equal to 5 hours and preferably still less than or equal to 4 hours.

The invention also relates to the doughs for bakery product comprising a sourdough according to the invention and the baked bakery products obtained by a method of preparation according to the invention.

The invention relates in particular to doughs for bakery product comprising a sourdough according to the invention as sole deliberate supply of lactic acid bacteria and thereby containing lactic acid bacteria of which at least 60%, preferably at least 75%, and preferably still at least 95% are homofermentative lactic acid bacteria capable of producing acetic acid by consuming lactic acid in the presence of a substantial deficiency of fermentable sugars, it being possible for said sourdough to be a sourdough according to any one of the embodiments described above. In the case of a sourdough according to the invention containing not only lactic acid bacteria, but also yeast, the dough may contain the sourdough according to the invention as sole supply of microorganisms.

The present invention also relates to the use of a sourdough according to the invention as a preserving agent for baked bakery product. It has indeed been observed that the use of a sourdough according to the invention as a preserving agent for baked bakery products, even if the microorganisms of the sourdough have been partially or completely deactivated, makes it possible to extend the shelf life of the baked product. The effect of said sourdough, whose microorganisms have been optionally partially or completely deactivated, as a preserving agent for baked product manifests itself, compared with a baked product prepared without using this sourdough, in particular, on the one hand, by a delay in the development of molds in and on the baked product and, on the other hand, by the fact that the baked product preserves its fresh appearance in the organoleptic sense for a longer period.

Thus, the invention relates to a method for extending the shelf life of a baked bakery product, said method comprising:
optionally the partial or total deactivation of the microorganisms of a sourdough according to the invention,
the preparation of a dough for bakery products by incorporating therein said optionally deactivated sourdough according to the invention, and
the baking of said dough in an oven so as to obtain a baked bakery product with prolonged shelf life.

The dough is preferably a dough containing baker's yeast which is subjected to a fermentation stage by this yeast before it is baked in an oven. The baked product may for example be of the bread, brioche or yeast raised sweet pastry type (“viennoiserie”).

The enumeration of the CFUs of lactic acid bacteria is described in the French standard NF ISO 15214 of September 1998. According to the protocol applied in the present context, an effective quantity of the antifungal cycloheximide is added to the composition of the MRS medium in order to avoid the development of yeasts which would result in biased or false results being obtained.

The enumeration of yeasts is described in the International standard ISO 7954 of 1987. The protocol applied in the present context uses an effective quantity of a nontoxic bactericide for yeasts such as chloramphenicol (see ISO 7954, paragraph 5.3), in order to avoid the development of bacteria which would cause biased or false results to be obtained. The protocol applied in the present context is however distinguishable from the method described in the standard in that the temperature is 30° C.

### EXAMPLES

### Example 1

### Preparation of a Ready-to-Use Sourdough According to the Invention

1) Preparation

a) Selection of Microorganisms

The homofermentative lactic acid bacterium capable of consuming lactic acid with production of acetic acid chosen is the Lactobacillus plantarum marketed under the name “Texel Dried L115” by the company Rhodia Food ZA De Buxières, BP 10-86220 Dange—Saint Romain (France)

b) Preparation of the Flour-Based Culture Medium

150 g of finely milled type 170 rye flour, 15 g of malted wheat flour and 835 g of water are mixed in a fermenter (7 liter Applikon® fermenter provided with 2 series of Rushton® blades, a pH probe, a pO₂ probe and aerated with an aerator in the form of a perforated tube, controlled by a bio-controller ADI® 1030 module, an ADI® 1032 speed regulator and an ADI® 1018 heat regulation from the same manufacturer).

c) Seeding

1 g of lyophilizate of the bacterium Lactobacillus plantarum is added to this flour-based culture medium.

d) First Fermentation

The mixture is allowed to ferment at 30° C. for 24 h, with moderate stirring (150 rpm), without aeration.

After 24 h, the pH is regulated at a reference value of 4.8.

This pH regulation is not essential but makes it possible to accelerate the consumption of the fermentable sugars and to avoid the development of a possible undesirable flora.

The mixture is again allowed to ferment for 24 h at 30° C.

The absence of directly fermentable sugars in the sourdough is then checked for by HPLC assay (Shimadzu® HPLC chain equipped with a Biorad® HPX 87 H column and using a refractometric detector and/or another UV absorbance detector).

e) Second Fermentation

The culture medium is aerated by a combined effect of vigorous stirring (400 rpm) and injection of air into the bottom of the fermenter in order to maintain the pO₂ at around 20%. The culture medium is allowed to ferment, with aeration, for 24 to 48 hours.

f) Storage

The sourdough thus obtained is cooled to 4° C. and it is stored at this temperature without stirring.

2) Results

At different times during the preparation of the sourdough, samples of flour-based culture medium are taken, these samples are centrifuged, diluted 1/10 in distilled water supplemented with 5 mM sulfuric acid, filtered on filter having a porosity of 0.45 μm and injected in HPLC (see reference above). The analytical results are presented in table 1.

The medium, at the end of the first fermentation, is depleted of fermentable sugars, all the simple sugars being consumed by the microorganisms.

These data make it possible to calculate the variation of the fermentation quotient (FR) during said second fermentation. These results are presented in table 2. The mole for mole conversion of lactic acid to acetic acid as a function of time is clearly observed. It is sufficient to stop the aeration at the desired FR in order to stop the production of acetic acid from lactic acid by the lactic acid bacteria of the selection and to stabilize the composition of the ready-to-use sourdough obtained.

### Example 2

### Preparation of a Sourdough Baker's Leaven Bread According to the Invention

The following prepared breads are compared by a tasting test:
a sourdough baker's leaven bread manufactured with a traditional final sourdough baker's leaven (“levain tout point”) produced on rye and provided at the rate of 30 kg of “levain tout point” per 100 kg of flour (bread 1), (unlike the other breads of the example and for this bread to possess all the characteristics of a traditional sourdough baker's leaven bread, a breadmaking process over 7 hours was used for bread 1)
a sourdough baker's leaven bread obtained with the ready-to-use sourdough of example 1 obtained with a second fermentation of 24 hours, used in an amount of 15 kg of sourdough per 100 kg of flour (bread 2)
a sourdough baker's leaven bread made with a ready-to-use sourdough according to the invention having a lactic acid content of 28 g/kg and an acetic acid content of 12 g/kg (bread 3)
a bread manufactured with a sourdough flavor, that is to say a dehydrated dry sourdough used in accordance with its data sheet at 3 kg per 100 kg of flour (bread 4)

The proportions of sourdough relative to the flour for the breads correspond to the recommended customary doses for use.

The formulas for the corresponding doughs (expressed as part by mass per 100 kg of flour, baker's percentage) are given in table 3.

The manufacturing process with 3 hours 40 minutes of fermentation between the end of kneading and the start of baking, that is 3 h 50 min if the kneading including the mixing is counted in the fermentation, is the following (the variants for bread 1 are provided in brackets):
Mixing: 8 minutes on the 1st speed in a spiral kneader with the VMI® trademark
Kneading: 2 minutes on the 2nd speed in a spiral kneader with the VMI® trademark
Bulk fermentation: 1 h 40 min (bread 1: 3 hours)
Weighing/rounding: dough piece weight 500 g
Rest: 0 h 50 min
Manual shaping: into a small loaf of bread
Proofing: 1 h 10 min (bread 1: 3 hours)
Baking: 0 h 45 min at 225° C. with steam

The lactic acid and acetic acid contents were measured in the crumb of the baked breads prepared with the various sourdoughs and are given in table 4. The breads were also subjected to a tasting test by a group of experts, the results are given in table 5.

The unanimous conclusion of the taste panel is that the ready-to-use liquid sourdough according to the invention makes it possible to obtain a sourdough baker's leaven bread which compares favorably with a traditional sourdough baker's leaven bread.

| | Lactic | Acetic | | Glu- | | Fruc- |
|---|---|---|---|---|---|---|
| | acid | acid | Ethanol | cose | Maltose | tose |
| | g/kg | g/kg | g/kg | g/kg | g/kg | g/kg |
| Flour-based medium | 0.0 | 0.0 | 0.0 | 1.0 | 6.0 | <1.0 |
| before seeding | | | | | | |
| Flour-based medium | 24.3 | 1.2 | 3.8 | 0.0 | 0.0 | 0.0 |
| at the start of the | | | | | | |
| second fermentation | | | | | | |
| Fermented flour- | 12.6 | 9.0 | 3.0 | 0.0 | 0.0 | 0.0 |
| based medium after | | | | | | |
| 24 h of the second | | | | | | |
| fermentation | | | | | | |
| Fermented flour- | 3.6 | 15.0 | 2.5 | 0.0 | 0.0 | 0.0 |
| based medium after | | | | | | |
| 48 h of the second | | | | | | |
| fermentation | | | | | | |

TABLE 1

| | Lactic | Acetic | Acetic acid + | Fermentation |
|---|---|---|---|---|
| | acid | acid | lactic acid | quotient |
| | mmol/kg | mmol/kg | mmol/kg | mmol/kg |
| Flour-based medium | 270 | 20 | 290 | 13.5 |
| at the start of the | | | | |
| second fermentation | | | | |
| Fermented flour- | 140 | 150 | 290 | 0.90 |
| based medium after | | | | |
| 24 h of the second | | | | |
| fermentation | | | | |
| Fermented flour- | 40 | 250 | 290 | 0.2 |
| based medium after | | | | |
| 48 h of the second | | | | |
| fermentation | | | | |

TABLE 2

| | Bread 1 | Breads 2 and 3 | Bread 4 |
|---|---|---|---|
| Wheat flour type 55 | 100 | 100 | 100 |
| Water | 60 | 58 | 63 |
| Salt | 2.0 | 1.8 | 2 |
| Compressed yeast | 0.2 | 0.6 | 1.0 |
| (at 30% of dry matter) | | | |
| Ready-to-use liquid sourdough | | 15 | |
| Traditional sourdough | 30 | | |
| Sourdough flavor | | | 3 |

TABLE 3

| | Bread 1 | Bread 2 | Bread 3 | Bread 4 |
|---|---|---|---|---|
| Lactic acid | 3700 ppm | 1800 ppm | 3300 ppm | 3600 ppm |
| Acetic acid | 900 ppm | 900 ppm | 1200 ppm | 150 ppm |

TABLE 4

| | Bread 1 | Breads 2 and 3 | Bread 4 |
|---|---|---|---|
| Type of | Traditional | Liquid sourdough | sourdough flavor |
| sourdough | sourdough | according to the | (inactive dry |
| | | invention | sourdough) |
| Appearance | Nice appearance, | Nice appearance, | Flat bread, dull, |
| crust | crust colored | red-brown | poor dough |
| | without being | coloration | tolerance and of |
| | excessive | slightly more | fermentation |
| | | intense than on | |
| | | the natural | |
| | | sourdough | |
| Appearance | Open to very open | Open crumb, | Dense crumb, |
| crumb | crumb, cream color | cream color | gray color |
| Odor crust | Acetic note without | Acetic note, | Burnt note, |
| | being excessive, | boiled sweet, | earthy |
| | boiled sweet, green, | caramel (1) | |
| | rosy | | |
| Odor crumb | Slightly acetic, | Slightly acetic, | Burnt note |
| | woody mushroom, | gingerbread, | |
| | gingerbread | honey, woody (1) | |
| Chewing | Elastic then | Elastic then | Packed, sticky |
| | melting | melting | |

TABLE 5

| | | | |
|---|---|---|---|
| Taste | Slightly sourish, | Acetic without being | Clear acidity, |
| | almond, fruity, | excessive, ginger- | metallic, without |
| | gingerbread | bread, fruity, | flavor |
| | | hazelnut, grilled, | |
| | | slightly acid (1) | |

(1) Flavors of bread 3 generally perceived more strongly than those of bread 2.

### Example 3

### Preparation of a “Sourdough Baker's Leaven Bread”, within the Meaning of the French Decret Pain (Bread Decree), According to the Invention

In France, the use of the name “sourdough baker's leaven bread” is regulated by Decree No. 93-1074, termed “Decret Pain”, of Sep. 13, 1993, published in the J.O. of Sep. 14, 1993, and amended by Decree No. 97-917 of Oct. 1st, 1997, published in the J.O. of Oct. 8, 1997. A “sourdough baker's leaven bread” within the meaning of said Decret Pain is prepared with the ready-to-use sourdough of example 1 obtained with the Lp 652 strain deposited at the CNCM under the number CNCM I-3069 with a second fermentation of 24 hours. This sourdough is used in an amount of 15 kg of sourdough per 100 kg of flour.

The formula for the corresponding dough (expressed as part by mass per 100 kg of flour, that is to say in baker's percentage) is given in table 6. The dough formula meets the requirements of the Decret Pain for the production of a “sourdough baker's leaven bread” within the meaning of the Décret Pain.

The sourdough is in particular the main agent of the fermentation because the dose of baker's yeast (expressed at 32% of dry matter) does not exceed 0.2% by weight relative to the flour.

The manufacturing process with 4 hours of fermentation is the following:
Mixing: 3 minutes on the 1st speed in a spiral kneader with the VMI® trademark
Kneading: 10 minutes on the 2nd speed in a spiral kneader with the VMI® trademark
Bulk fermentation: 3 hours in bulk at 35° C.
Weighing/rounding: dough piece weight 500 g
Rest: 0 h 10 min
Manual shaping: into a brick
Proofing: 0 h 50 min at 35° C.
Baking: 0 h 35 min at 230° C. with steam

The lactic acid and acetic acid contents and the pH were measured in the crumb of the baked bread prepared with the sourdough and are given in table 7. The pH values of the crumb (4.20) and the acetic acid content (1300 ppm) meet the requirements of the Decret Pain for the label “sourdough baker's leaven bread”.

The ready-to-use liquid sourdough according to the invention therefore makes it possible to obtain, within only 4 hours between the end of kneading and the start of baking, a “sourdough baker's leaven bread” meeting the preparation and acidity criteria set by the Decret Pain (or within only 4 hours 13 minutes between the start of kneading including the slow mixing and the start of baking).

The bread was also subjected to a tasting test by a group of experts, the results are given in table 8.

TABLE 6

| | |
|---|---|
| Wheat flour type 55 | 100 |
| Water | 60 |
| Salt | 2.0 |
| Compressed yeast (at 32% dry matter) | 0.2 |
| Ready-to-use liquid sourdough | 15 |

TABLE 7

| | |
|---|---|
| Lactic acid | 4550 ppm |
| Acetic acid | 1300 ppm |

TABLE 8

| | |
|---|---|
| Type of sourdough | Liquid sourdough according to the invention |
| Appearance crust | Nice appearance, red-brown coloration |
| | slightly more intense than on a natural |
| | sourdough baker's leaven bread |
| Appearance crumb | Open to very open crumb, cream color |
| Odor crust | Acetic note, grilled, caramel, malted |
| Odor crumb | Acetic, woody, slightly acid, honey |
| Chewing | Elastic then melting |
| Taste | Pleasantly sourish, fermented cereals, |
| | hazelnut, fruity, slightly acid |

1-21. (canceled)

22. A ready-to-use sourdough comprising
a flour-based culture medium comprising at least one cereal flour and water, wherein the culture medium is seeded and fermented with a selection of microorganisms, the selection comprising lactic acid bacteria;
acetic acid in the amount of at least 7 g/l; and
optionally lactic acid;
wherein the amount of the lactic acid bacteria is at least 10⁸ colony forming units (CFU) per gram, and wherein at least 60% of the lactic acid bacteria is homofermentative lactic acid bacteria which bioconvert lactic acid;
wherein the sourdough has a pH between 3.8 and 4.5, and a fermentation quotient FR less than or equal 4.75 and
wherein the sourdough contains less than 5 g/kg of sugars fermentable by the microorganisms.

23. The ready-to-use sourdough of claim 22 containing between 12 and 50% by mass of a dry matter.

24. The sourdough of claim 22, further comprising yeast.

25. The sourdough of claim 24, wherein the amount of the yeast is at least 10⁵ CFU per gram.

26. The sourdough of claim 25, wherein the sourdough preserves the CFU amount of the lactic acid bacteria and/or the CFU amount of the yeast when stored at a temperature equal or less than 8° C. for at least one month.

27. The sourdough of claim 22, further comprising an enzymatic preparation comprising amylase.

28. A dough prepared by a process comprising using the sourdough of claim 22 as a fermentation agent.

29. The dough of claim 28, wherein said process is a straight dough process comprising supplying an amount of baker's yeast that is equal or less than 1% by mass of an amount of flour.

30. A method for preparing a baked product, comprising preparing a dough by a process comprising using the sourdough of claim 22 as a fermentation agent; wherein said process is a straight dough process comprising kneading said dough and baking said dough, wherein a period between the start of said kneading and the start of said baking is equal or less than 6 hours.

31. A method of preparing fermented dough, the method comprises preparing a dough comprising water, flour and the sourdough of claim 22; fermenting the prepared dough.

32. A dough for bakery products, said dough comprises the sourdough of claim 22.

33. A method of preserving a baked bakery product, comprising using the sourdough of claim 22 as a preservation agent in the bakery product.

34. The method of claim 33, further comprising deactivating partially or totally said sourdough of the microorganisms prior to said using.

35. A ready-to-use sourdough baker's leaven bread made by a breadmaking process having a fermentation time between the start of kneading and the start of baking less than 4 hours 30 minutes, wherein a fermentation agent used in the bread making process consists essentially of sourdough, and wherein a crumb of the bread has a pH ≦4.3, and an acetic acid content of at least 900 ppm by weight.

36. A homofermentative lactic acid bacterium which bioconverts lactic acid belonging to the Lp 652 strain of Lactobacillus plantarum deposited on Jul. 16, 2003 at the CNCM under the registration number CNCM 1-3069.

37. A method of manufacturing a ready-to-use sourdough, comprising carrying out a selection of microorganisms, wherein the selection comprises lactic acid bacteria, which bioconvert lactic acid, wherein the lactic acid bacteria comprise homofermentative lactic acid bacteria;
preparing a flour based culture medium comprising at least one cereal flour and water;
seeding the flour based culture medium with the selection of microorganisms;
performing a first fermentation of the flour based culture medium with the selection of microorganisms to substantially deplete fermentable sugars in the culture medium;
performing a second fermentation of the culture medium with the selection of microorganisms to adjust a fermentation ratio of the flour based culture medium.

38. The method of claim 36, wherein performing a second fermentation is carried out in the presence of an electron acceptor.

39. The method of claim 37, wherein the electron acceptor is selected from the group consisting of oxygen, citrate, fructose, glycerol and combinations thereof.

40. The method of claim 36, wherein the sourdough comprises acetic acid and optionally lactic acid and wherein all or substantially all of the acetic acid and the lactic acid are produced by the microorganisms.

41. The method of claim 36, further comprising preserving the manufactured sourdough at a temperature less or equal 8° C.

42. A ready-to-use sourdough manufactured by the method of claim 36.

43. A method of manufacturing a ready-to-use sourdough, comprising
carrying out a selection of microorganisms, wherein the selection comprises lactic acid bacteria, wherein the lactic acid bacteria comprise homofermentative lactic acid bacteria which bioconvert lactic acid;
preparing a first culture medium for the lactic acid bacteria, said first culture medium comprises water and substances for growth of the lactic acid bacteria;
seeding the first culture medium with the homofermentative lactic acid bacteria which bioconvert lactic acid of the selection;
performing a first fermentation of the first culture medium with the homofermentative lactic acid bacteria to substantially deplete fermentable sugars in the culture medium;
performing a second fermentation of the first culture medium with the homofermentative lactic acid bacteria which bioconvert lactic acid, to adjust a fermentation quotient of the culture medium to an intermediate level and to obtain a preculture of the homofermentative lactic acid bacteria;
preparing a second flour-based culture medium comprising at least one cereal flour and, water;
seeding the second flour-based culture medium with the preculture of the homofermentative lactic acid bacteria and optionally seeding the flour based culture medium with the microorganisms of the selection which have not served for the preparation of the preculture;
fermenting the second flour-based culture medium with the selection of microorganisms of the selection not used in obtaining of the preculture.

44. The method of claim 43, wherein performing a second fermentation is carried out in the presence of an electron acceptor.

45. The method of claim 43, wherein the electron acceptor is selected from the group consisting of oxygen, citrate, fructose, glycerol and combinations thereof.

46. The method of claim 43, wherein the sourdough comprises acetic acid and optionally lactic acid and wherein all or substantially all of the acetic acid and the lactic acid are produced by the microorganisms.

47. The method of claim 43, further comprising preserving the manufactured sourdough at a temperature less or equal 8° C.

48. A ready-to-use sourdough manufactured by the method of claim 43.
